(19) United States
(12) Patent Application Publication
(10) Pub. No.: US 2011/0062147 A1
(43) Pub. Date: Mar. 17, 2011

(54) SELF-REGULATING ELECTRICAL RESISTANCE HEATING ELEMENT

(76) Inventor: Jeffery Boardman, Warrington (GB)

(21) Appl. No.: 12/992,952

(22) PCT Filed: Jun. 9, 2009
(86) PCT No.: PCT/GB09/50643

§ 371 Date: Nov. 16, 2010

(30) Foreign Application Priority Data
Jun. 9, 2008 (GB) 0810513.2

(51) Int. Cl. H05B 3/10; H01C 17/02

(52) U.S. Cl. 219/553; 29/611

(57) ABSTRACT

The present invention relates to a self-regulating electrical resistance heating element, to an appliance containing same, and to processes for their manufacture. The self regulating electrical resistance heating element comprises: a non-electrically conductive substrate (12); a first metal oxide (14) having a positive or negative temperature coefficient of resistance below a predetermined operating temperature deposited on said substrate; a second metal oxide (16) having a temperature coefficient of resistance opposite to that of said first metal oxide deposited on said substrate adjacent said first metal oxide; and first and second electrical contacts (18; 20) disposed such that a current can pass between the contacts through the first and second metal oxides. By placing the respective metal oxides, in e.g. discreet lines, tracks or areas, adjacent one another, with a contact there between or with a sufficient overlap to ensure a good electrical contact it is possible to provide self-regulating electrical resistance heating elements for applications where a large area (compared to 20 e.g. a kettle element) is needed, such as might be the case in a washing machine, dishwasher or tumble dryer.

### TECHNICAL FIELD

The present invention relates to a self-regulating electrical resistance heating element, to an appliance containing same, and to processes for their manufacture.

### BACKGROUND OF THE INVENTION

Conventional electrical heating elements of the tubular sheathed variety or screen printed type do not have self-regulating properties and when connected to an electrical power source will continue to heat up until they fail by burning out and self-destructing.

The safe use of these conventional elements in appliances is achieved by combining them in series with some form of temperature sensitive control device, which effectively cuts off the electrical supply when a predetermined temperature level has been reached.

Generally these temperature sensitive control devices incorporate bimetals in various configurations and rely on the ability of the bimetallic components to deflect at or around a predetermined temperature to provide a mechanical action which “breaks” the electrical supply contacts, thus interrupting the electrical power supply to the elements concerned.

Whilst such temperature sensitive bimetallic and other similar control devices are widely used, and are produced to high quality standards, they are generally mechanical and like all mechanical mass produced devices are subject to the probability of failure, which increases with usage.

The operational failure of such temperature sensitive control devices will result in the over-heating and self-destruction of the associated elements, with potentially catastrophic results for the user.

Electrical heating elements are available which have self-controlling characteristics. These are manufactured from various compositions of, usually, barium titanate doped with small quantities of other metals. Their resistance increases by several powers of ten when the temperature is raised to the vicinity of the Curie point, also known as the “switching” temperature. However, such heating elements have a number of limitations which severely limit their widespread application and usage. Some of these are set out below:
The major disadvantage of doped barium titanates is the inherent property that the resistivity of such materials is not constant over the temperature range from ambient to the “switching” temperature or Curie point, but rather resistivity reduces progressively with increasing temperature before increasing to a high value.
A further disadvantage is that the rate and magnitude of reduction of resistance in such materials varies appreciably according to the composition and concentration(s) of the dopant or combination of dopants used.

As a consequence of the above, heating elements manufactured from such compositions exhibit operational resistances which reduce significantly from that measured at ambient temperature, to that just prior to the “switching” temperature or Curie point, a reduction which can be as high as half of the original resistance. Furthermore this reduction occurs in an unpredictable manner.

The above failings present the domestic appliance manufacturers and others utilising such elements with the problem of deciding which ambient resistance to produce such elements to, in order to maximise the power output.

In explanation of this, consider the use of a conventional element in a domestic water heating device operating with a single phase 230 volt AC supply. The maximum current allowed for 230 volt appliances is 13 amps and by Ohm's Law this defines the maximum power output of such single element appliances to circa 3 kilowatts, and consequently the minimum resistance of the heating element employed to 17.7 ohms.

In general, the resistance of such conventional elements does increase slightly with increases in operating temperature, but only by some 1-2%. Consequently the generation of heat by the element, and transfer of this energy to the water, is at a maximum when the temperature is at a minimum and is only slightly reduced from this as the boiling point is reached.

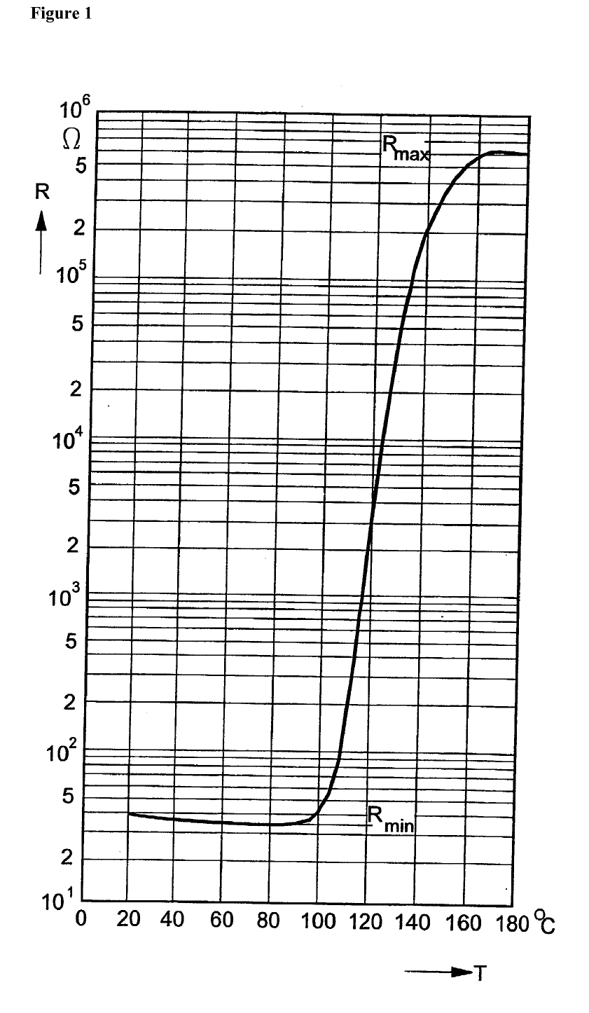

The same power and current limitations apply to doped barium titanate elements such that the minimum resistance of 17.7 ohms would need to be at a temperature near the “switching” or Curie point, resulting in a higher resistance at ambient temperature. Assuming a resistance decrease over the appropriate temperature range of, say, 25%, a typical doped barium titanate element would need to be produced with an ambient resistance of 23.6 ohms. Using Ohm's Law it can be shown that at the start of the water heating cycle the thermal energy available is only 2.24 kw, rising to 3 kw only when the boiling point is reached. This is the opposite effect of that required by the domestic appliance manufacturers and an example of the resistance-temperature characteristic of a doped barium titanate composition with the Curie point “switching” temperature at 120° C. is shown in FIG. 1.

A yet further disadvantage with doped barium titanate elements arises from the method used to produce them. Doped barium titanates derive their particular temperature/resistance properties mainly from the characteristics of the grain boundaries between the individual particles making up the bulk matrix of any particular piece. Thus, objects made of doped barium titanates are produced by pressing together, to the appropriate size and shape depending on the required finished object, the required amount of fine powder particles of the appropriate composition in a press, usually with a binding agent and then sintering the pressed mass in a furnace at the requisite temperature to produce a homogeneous product. Whilst this is an adequate manufacturing process it may result in products which are not fully dense from the pressing stage, and therefore do not exhibit uniform operating characteristics or have residual stresses from the sintering stage. As a consequence they are prone to cracking and operational failure during subsequent thermal cycles. Accordingly it is necessary to pre-test the elements with failing elements being discarded.

The inventor has previously proposed using two different metal oxides to produce a self regulating heating element. Published applications include GB2344042, GB237383 and GB 2374784. The most pertinent is GB2374783 which proposes using successive layers (emphasis added) of different metal oxides deposited on an electrically conductive metal substrate, the layers of metal oxides having both different compositions and degrees of oxidation. Indeed, it proposes the use of nickel-chrome type metal oxides in combination with barium titanates. Significantly, both this and the other applications teach methodology in which both metal oxide layers are deposited using thermal spraying techniques. The inventor has found that the methodology employed and disclosed in the earlier applications did not result in elements having the desired characteristics because the thermal spraying of the doped barium titanates resulted in the destruction of the dopants.

In international patent application No PCT/GB2007004999, presently not published, the inventor discloses methodology which resulted in self regulating heating elements, in which successive layers are laid down, having the desired characteristics.

The inventor has now determined that, as well as laying down the different metal oxides “on top of one another” and passing a current through the layers, it is also possible to place the respective metal oxides, in e.g. discreet lines, tracks or areas, adjacent one another, with a contact there between or with a sufficient overlap to ensure a good electrical contact.

Such an alternative arrangement was not, in the first instance, apparent to the inventor.

Such an arrangement overcomes the problem of applying the principle to those heating applications where a large area (compared to e.g. a kettle element) is to be covered, such as might be the case in a washing machine, dishwasher or tumble dryer or in large area domestic applications such as convector heating, under floor heating, storage heaters etc, where certainty of control is essential to avoid fires.

Electrically connecting the metal oxides in a linear fashion overcomes this problem allowing large areas to be covered.

Of course, GB2307629 and GB2340367 disclose arrangements in which resistive tracks, having different temperature coefficients are used, but both rely on external circuitry or switching device to achieve operational control and prevent overheating of the electrical elements. Consequently they are not “self regulating”.

More particularly, GB2307629 discloses an element made up of two different lengths of resistive tracks, having different temperature coefficients of resistance in series. The effect of combining the tracks is that an operational voltage drop across each is markedly different and varies with an increase in temperature. A separate control circuit is used to continuously compare the changes in voltage drop across the two separate tracks and to switch off the power, i.e. cease operation, once a particular voltage loss ratio is reached at a particular operating temperature. Regulation of the element is therefore entirely dependent on the external control circuitry, NOT on a property of the materials comprising the resistance track.

In GB2340367, operational temperature limitation relies on the triggering of a conventional bimetallic switch connected in series with the supply to the element. This bi metallic switch is ‘preferentially’ triggered by locating it above, or very close to, a small portion of the heating element track which has a negative temperature resistance coefficient and which preferentially heats up more than the bulk of the resistance track, which has a positive temperature resistance coefficient. However the preferential temperature rise of the negative temperature coefficient resistance portion of the track is dependent upon restricting the presence of cooling water to that area of the element above the negative temperature coefficient resistance by use of an enclosure device.

Whilst both the above patents mention element tracks made up of two components having different temperature coefficient resistances, final control in both is achieved using external switches and/or control circuitry.

Moving from a stacked arrangement, where the substrate actually forms part of the conductive circuit, and the track length of the metal oxide resistive elements is of the order of 80-160 microns only, to a side-by-side arrangement, where the track length will be measured in centimetres (or possibly even metres) is far from obvious. The different arrangements present totally different material challenges. Also, in contrast to the stacked arrangement, the substrate used for the side-by-side arrangement is non-conductive and does NOT form part of the electrical resistance circuit. Applying the 2 metal oxide element compositions to these two very different substrates again brings different challenges

### PRESENT INVENTION

According to a first aspect of the present invention there is provided a self regulating electrical resistance heating element comprising:
a non-electrically conductive substrate (12);
a first metal oxide (14) having a positive or negative temperature coefficient of resistance below a predetermined operating temperature deposited on said substrate;
a second metal oxide (16) having a temperature coefficient of resistance opposite to that of said first metal oxide deposited on said substrate adjacent said first metal oxide;
first and second electrical contacts (18; 20) being disposed such that a current can pass between the contacts through the first and second metal oxides
and wherein, in combination the first and second metal oxides provide a substantially constant combined resistance from an ambient to the predetermined operating temperature and a very substantial increase in resistance above the operating temperature.

By providing an electrical heating element which has the required self-controlling characteristic in that the resistivity and resistance of the said element are nearly constant over the temperature range from ambient to the required operation limit, but which once the operating temperature marginally exceeds that predetermined operating limit the resistance increases by a power of ten or more, a safer and more efficient element results.

Furthermore, the methodology for their production ensures greater consistency is achieved during production of such elements.

Preferably, the first and second metal oxides are selected to provide a constant combined resistance from an ambient to a predetermined operating temperature and a very substantial increase in resistance above the operating temperature.

In a favoured embodiment the first metal oxide is an oxide of at least nickel and chromium and most preferably at least nickel, chromium and iron and the second metal oxide is a ferro-electric material.

Preferably, the ferro-electric material is a crystalline structure of the perovskite type and is of the general formula ABO₃ where A is a mono-, di- or tri-valent cation, B is a penta-, tetra- or tri-valent cation and O₃ is an oxygen anion.

Most preferably, the ferro-electric material is a doped barium titanate.

Typical dopants are those familiar to the man skilled in the art and include: lanthanum, strontium, lead, caesium, cerium and other elements from the lanthanide and actinide series.

Preferably the ferro-electric material comprises granular particles and said granular particles are more preferably deposited in a liquid or as a slurry, dispersion or paste. It is important that the ferro-electric material is deposited in a manner which does not result in its resistive properties, which are characterised by, amongst other things, the dopants used, being altered. In this respect thermal processes which can vaporize the dopant or otherwise destroy the material are not used since the resulting product will not have the desired characteristics.

Preferably the particles are fine particles with a size range of from 20-100 microns and are deposited in a layer having a thickness of typically, from 100 to 500 microns.

Such mixed ferro-electric metal oxides are also generally known as oxygen—octahedral—ferro-electrics, and the characteristics of these materials, which include initial resistivity, variation of resistivity with temperatures, and Curie point or “switching” temperature, may be varied by variations in composition.

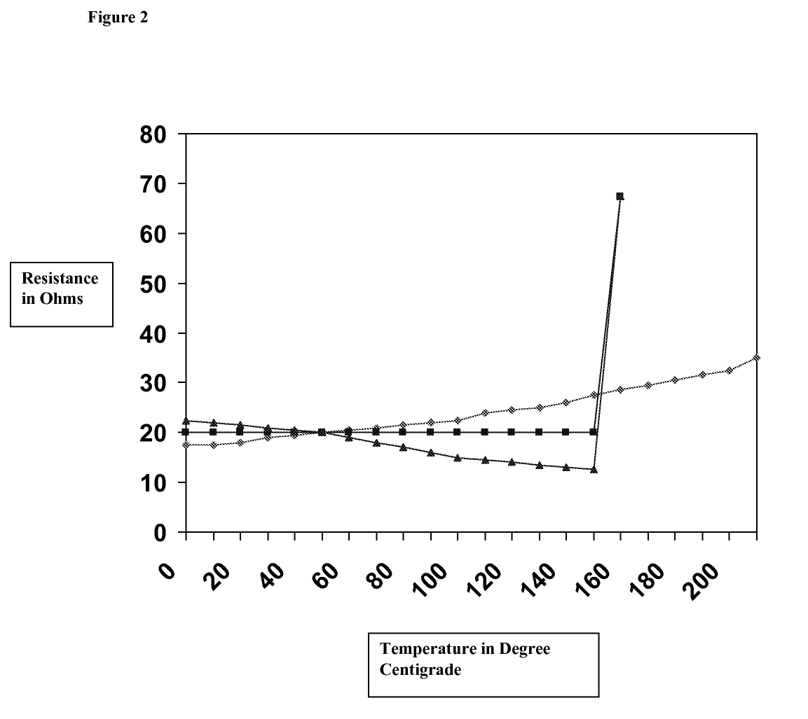

All the oxygen—octahedral—ferro-electric metal oxides exhibit the characteristic of reducing resistivity (negative temperature coefficient of resistance) with increasing temperature up to the Curie point or “switching” temperature and this is compensated for in the elements of the invention by placing one or more different metal oxides (with a positive temperature coefficient of resistance) in series such that the resistivity is “balanced”. This is most clearly illustrated in FIG. 2.

The process for deriving this balanced compensation in reduction in resistance is not straightforward, involving a combination of calculation and empirically observed behaviours. Factors involved in the consideration include:
the end-value of the Curie point required,
the nature of the oxygen-octahedral-ferro-electric metal oxide to be used,
the nature and concentration of the dopant or dopants to be used,
the resultant rate of decrease in the resistivity and resistance to the Curie point,
the nature and composition of the metal oxide or metal oxide combinations which it is necessary to apply in order to compensate both the initial resistance level at ambient temperature and the rate of increase of the same to the required Curie point, and
the physical thickness (and consequent economic cost) of the two layers as well as the resultant temperature differential operating between the combination.

In essence, the selection of suitable combinations for a given purpose involves a degree of trial and error, taking into account the above.

Achievement of the required initial level of resistance for the thermally sprayed resistive metal oxide or metal oxide combinations (Nickel/Iron/Chromium) may optionally include adjustment using an intermittently pulsed high voltage electric current, either AC or DC, and which is the subject of UK patent application GB2419505 (PCT/GB2005/003949).

Thus, the increase in resistance with temperature of the Nickel/Iron/Chromium type metal oxide layer, essentially offsets the decrease in resistance with temperature of the doped barium titanate layer such that the combined resistance of the two resistive layers remains substantially constant from ambient to a predetermined operating temperature, but at the pre-determined operating temperature, the Curie point or “switching” temperature of the doped barium titanate layer, the resistance of this layer increases by several powers of ten effectively increasing the overall combined element resistance to a high level, thus reducing the thermal power output to a very low level and acting as a self-regulating mechanism to prevent the element over-heating at temperatures above the predetermined operating level.

Given the above it is essential that in depositing the respective metal oxides that their characteristic resistivity is not altered such that they will not function as originally intended.

The resistive properties of the doped barium titanates derive mainly from the grain boundary effects at the junctions between successive particles; The smaller the particle size range, the greater the number in any given volume of the barium titanate layer, and the greater the resistivity of the layer. The process of depositing doped barium titinates using a thermal process, such as flame spraying, changes the resistive properties, probably as a result of the destruction of the dopants. It also destroys the Curie point/switching effect.

In a favoured embodiment the first and second metal oxides are in intimate contact, and preferably overlap, at their boundary. Alternatively, an electrically conductive layer can be used to bridge the boundary and provide a better contact.

The electrically conductive bridge may be any electrically conductive metal or metal alloy including, for example, aluminium, copper, mild or stainless steel.

According to a second aspect of the present invention there is provided an electrical appliance comprising a heating element of the invention.

According to a third aspect of the present invention there is provided a process for the manufacture of a self regulating resistance heating element comprising:
Applying a first metal oxide (14), having a positive or negative temperature coefficient of resistance below a predetermined operating temperature, to a non-electrically conductive substrate;
Applying a second metal oxide (16), having a temperature coefficient of resistance opposite to that of said first metal oxide, to the substrate adjacent said first metal oxide;
Applying first (18) and second (20) electrical contacts such that a current can pass between the contacts through the first and second metal oxides
and wherein in combination the first and second metal oxides provide a substantially constant combined resistance from an ambient to the predetermined operating temperature and a very substantial increase in resistance above the operating temperature.

The various aspects of the invention will be described further, by way of example, with reference to the following Figs in which:

FIG. 1 is a graph showing the resistance temperature characteristics of a barium titinate composition with a Curie point “switching” temperature at 120° C.;

FIG. 2 is a similar graph with the data for a Ni/Cr/Fe metal oxide superimposed against the data for a doped barium titanate to illustrate the “smoothing out” of the resistances; and

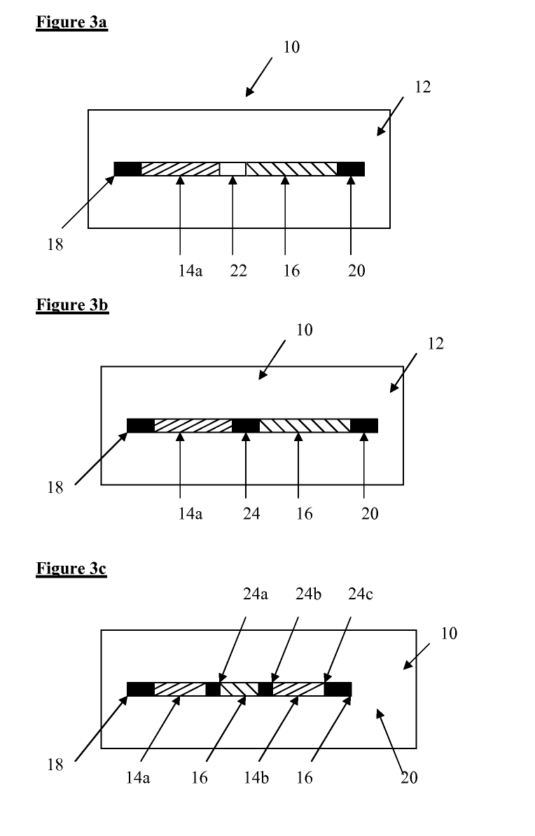

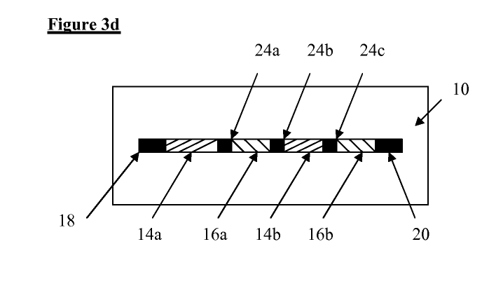

FIGS. 3a-d are plan diagrams of alternative configurations of a heating element of the invention.

### DETAILED DESCRIPTION

FIG. 1 illustrates the resistance temperature characteristics of a barium titinate composition with a Curie point “switching” temperature at 120° C. It will be noted that between 20° C. and 100° C. the metal oxide has a negative temperature coefficient of resistance and that between 100° C. and 140° C. the resistance increases very significantly.

In FIG. 2, the resistance/temperature data for a metal oxide of the nickel, chromium and iron type which has a positive coefficient of resistance is shown together with that of a doped barium oxide with a Curie point of 160° C. Before reaching the Curie point the negative and positive resistances effectively cancel one another out (intermediate line) to provide a substantially constant resistance that then increases significantly at the Curie point. This increase in resistance is a consequence of the tetragonal crystalline form changing to a cubic form, locking up electrons and eliminating conduction.

### Example 1

### Construction

Referring to FIG. 3a the self regulating electrical resistance heating element (10) comprises a non-conductive substrate (12) having deposited thereon, in a linear fashion, first and second metal oxides (14; 16). A first electrical contact (18) is disposed on one side of the adjacent metal oxides and a second electrical contact (20) is disposed on the other side such that a current is forced to pass consecutively from the first electrical contact, through the first and second metal oxides, to the second electrical contact. The first and second metal oxides may be deposited in a manner such that there is an overlap (22) there between or (as illustrated in FIG. 3b) a further electrical contact (24) may be provided to ensure good electrical connection.

Where the first metal oxide (14) has a positive temperature coefficient of resistance the second metal oxide layer (16) has a negative temperature coefficient of resistance and vice versa.

A current can be passed between the first and second electrical contacts, along the respective metal oxide layers which may take the form of e.g. discreet lines, tracks or areas.

In the embodiment illustrated the supporting substrate (12) may be a ceramic tile onto which has been deposited a thermally sprayed resistive metal oxide layer comprising e.g. Nickel/Iron/Chromium (14). Disposed adjacent, and in overlapping arrangement at the boundary there between (22), is a layer of doped barium titanate (16). First and second electrical contacts (18) and (20) are provided at the respective ends of the metal oxide layers such that a current can pass from one side to another.

It will be noted that the respective metal oxides have been deposited such that a current passing between the first and second contact is forced along the adjacent resistive layers which typically take the form of discreet tracks.

The supporting substrate may have a wide variety of shapes and configurations ranging from a flat plate (as illustrated) to shapes including spheres, hemispheres, and hollow tubes of round or square cross-section, being either continuously straight or bent into helical or toroidal forms.

The shape of the supporting substrate will be determined by the requirement to optimise the transfer of the thermal energy developed by the electrical heating element to the media required to be heated by the particular appliance concerned.

The contacts 18, 20, 24 may be comprised of any electrically conductive material such as copper, nickel, aluminium, gold, silver, brass or conductive polymers, and may be applied by a broad variety of means, illustrated by (but not restricted to) flame spraying, chemical vapour deposition, magnetron sputtering techniques, electrolytic or chemical processes, to a solid piece being held in place with adhesives, mechanical pressure or magnetic means.

It is preferable, but not necessary, to make that area of the contact to which the external power supply point is to be fixed thicker than the remaining areas to assist in the even distribution of the current.

The supporting substrate may be comprised of any electrically insulating material and should be of a sufficient thickness to provide dimensional stability for the element during production and subsequent operational use.

In FIG. 3c there is illustrated an embodiment in which a metal oxide with a negative coefficient (16) is deposited between two metal oxides with a positive coefficient (14a; 14b)

In FIG. 3d there is illustrated an embodiment in which a plurality of self regulating electrical resistance heating elements are arranged in series such that different temperature controls can be applied to different situations. Thus, different first metal oxides (14a and 14b) and different second metal oxides (16a and 16b) are laid down with e.g. contacts (24a, 24b and 24c) therebetween.

An advantage of such an arrangement is that the ferro-electric oxide element can be positioned at the most sensitive position such that it can respond to the temperature of the base substrate directly at the point where heat is being transferred to the medium being heated, giving added safety to the system as well as energy efficiency savings when compared with conventional bi-metal strips which have to be positioned relatively remote from this zone.

### Example 2

### Methodology

The heating elements may be manufactured by, for example, thermally spraying a resistive metal oxide (14) with a positive temperature coefficient of resistance onto a substrate (12). Indeed, successive layers of the metal oxide may be applied by making a plurality of passes (anywhere from 1 to 10, more preferably 2 to 5, depending on the desired thickness—typically up to 500 μm) using thermal spray equipment. Since the electrical resistance of the resistive metal oxide deposit is dependent upon the thickness, it is possible to decrease the resistance by increasing the thickness of the layer deposited. It is therefore preferred to deposit several layers.

It is known that metal alloys comprised of the nickel-chrome type when oxidised and thermally sprayed exhibit the desired characteristic of increasing resistivity/resistance with increased temperature. Such metal alloys are described in, for example, EP302589, U.S. Pat. No. 5,039,840 and PCT/GB96/01351. Such nickel-chrome type metal alloys may be oxidised to the required degree, as a precursor operation, prior to being thermally sprayed as one or more layers of the resistive metal oxide deposit, as described in GB2344042, or may be oxidised to the required degree during the thermal spraying operation. Indeed, the levels of, and rates of increase, in the resistivity and resistance of this metal oxide alloy layer with increasing temperature are significant factors in compensating for the asymmetric decreases in resistivity and resistance of the ABO₃ resistive oxide layer.

The other applied resistive oxide layer is preferably a doped barium titanate layer. It should not be deposited at high temperatures or it's resistivity is compromised. In a preferred embodiment it is applied in the form of a liquid or a paste, dispersion or slurry, comprising fine particles of barium titanate together with a dopant or dopants selected to match the predetermined operational switching temperature for a particular element design, the whole having been pre-sintered.

The paste, dispersion or slurry may be produced by the grinding of doped barium titanate pellets which have been produced to the required composition with appropriate Curie point characteristics and incorporating them into, for example, a suitable liquid adhesive.

The paste, dispersion or slurry (16) may then be applied adjacent the first resistive metal oxide layer (14) by any of a broad range of suitable means, including, but not being limited to, screen printing, painting, K-bar coating, spraying or the application of a quantity with subsequent smoothing out.

The liquid adhesive may be of any suitable composition such that it has the characteristics of binding the pre-mentioned fine doped barium titanate particles in close proximity to one another, to achieve the required grain boundary contact, and intimacy at the boundary with the other metal oxide and a second electrical contact.

Indeed, the adhesive may be one which cures or sets at ambient or elevated temperatures (but not so high as to alter the resistive characteristics of the metal oxide) or by being exposed to air, light curing or a chemically initiated curing process.

Again, the electrical resistance of the doped barium titanate layer may be controlled by altering the particle size range and the thickness of the applied paste, dispersion or slurry.

Alternatively, it may be possible to deposit a layer using magnetron sputtering under controlled temperatures and vacuum.

A second electrical contact (20) may be applied to the end of the doped barium titanate layer, such that a voltage supply (V) can be applied from the first electrical contact (18) across the metal oxide layers.

This second electrical contact may be comprised of any electrically conductive material such as copper, nickel, aluminium, gold, silver, brass or conductive polymers and may be applied by any suitable means, exemplified by, but not restricted to, chemical vapour deposition, magnetron sputtering techniques, electrolytic or chemical processes, and applying a solid piece with adhesives, mechanical pressure or magnetic means.

The electrical contact should have a thickness such that it will carry the maximum current required and allow it to distribute evenly over the whole of its surface so that the current passing across the metal oxides is uniform in density for each unit area of the metal oxide. This provision ensures that the heat energy generated within the volume of the combined element is uniformly distributed, producing a uniform temperature over the appropriate area of the supporting substrate without any localised hot spots.

It will be apparent to the skilled man that the different metal oxides can be deposited in any order depending on the methodology used.

### Example 3

### Alternative Methodology

The metal oxides comprising the different layers of the self-regulating heating element may be applied to the supporting substrate in a variety of ways using different techniques.

A first methodology is to deposit a first metal oxide produced from e.g. Ni—Cr—Fe, or similar alloys to a part of the substrate. It may be deposited by thermally spraying it over a given area and in a given configuration to the required calculated thickness. The second metal oxide, produced from e.g. doped barium titinate, is then applied adjacent the first metal oxide, again to the required calculated thickness and configuration the object being to “match” the two metal oxides to produce the required combined properties and characteristics of the heating element concerned.

Alternatively, the reverse of this first methodology may be utilised, whereby the oxygen—octahedral—ferro-electric oxide component is firstly applied to the supporting substrate followed by the second component metal oxide.

In other words, by selecting different metal oxides it is possible to determine, by the use of calculation and of empirically observed behaviours the dimensions and relationship between the various components comprising the type of electrical resistance heating element which is the subject of this present invention.

1-15. (canceled)

16. A self regulating electrical resistance heating element comprising:
a non-electrically conductive substrate;
a first metal oxide having a positive or negative temperature coefficient of resistance below a predetermined operating temperature deposited on said substrate;
a second metal oxide having a temperature coefficient of resistance opposite to that of said first metal oxide deposited on said substrate adjacent said first metal oxide;
first and second electrical contacts being disposed such that a current can pass between the contacts through the first and second metal oxides and wherein;
wherein said first and second metal oxides provide a substantially constant combined resistance from an ambient to the predetermined operating temperature and a very substantial increase in resistance above the operating temperature such that regulation is controlled by the resistive properties of said first and second metal oxides.

17. The self regulating electrical resistance heating element according to claim 16, wherein one of said first and second metal oxides is an oxide produced from an alloy consisting of at least one of a nickel, iron and chromium.

18. The self regulating electrical resistance heating element according to claim 17, wherein the other of said metal oxide is a ferro-electric material.

19. The self regulating electrical resistance heating element according to claim 18, wherein said ferro-electric material is a crystalline structure of a perovskite type and is of a general formula ABO₃ where A is a mono-, di- or tri-valent cation, B is a penta-, tetra- or tri-valent cation and O₃ is an oxygen anion.

20. The self regulating electrical resistance heating element according to claim 19 is a doped barium titanate.

21. The self regulating electrical resistance heating element according to claim 20 further comprising granular particles.

22. The self regulating electrical resistance heating element according to claim 21, wherein said granular particles are deposited as at least one of a liquid, a slurry, a dispersion, and a paste.

23. The self regulating electrical resistance heating element according to claim 22, wherein said granular particles having a particle size of 20-100 microns

24. The self regulating electrical resistance heating element according to claim 23, wherein said ferro-electric material is present in a layer having a thickness of up to 500 μm.

25. The self regulating electrical resistance heating element according to claim 24, wherein said first and second metal oxides overlap at a boundary of said first and second metal oxides.

26. The self regulating electrical resistance heating element according to claim 25, wherein said first and second metal oxides are separated by an electrically conductive contact.

27. The self regulating electrical resistance heating element according to claim 26 further comprising an electrical appliance comprising said self regulating electrical resistance heating element.

28. The self regulating electrical resistance heating element according to claim 27, wherein said substrate is non-planar.

29. A method for the manufacture of a self regulating resistance heating element, said method comprising the steps of:
applying a first metal oxide, having a positive or negative temperature coefficient of resistance below a predetermined operating temperature, to a non-electrically conductive substrate;
applying a second metal oxide, having a temperature coefficient of resistance opposite to that of said first metal oxide, to the said substrate adjacent said first metal oxide; and
applying first and second electrical contacts such that a current can pass between said first and second electrical contacts through said first and second metal oxides;
wherein in combination said first and second metal oxides provide a substantially constant combined resistance from an ambient to the predetermined operating temperature and an increase in resistance above the operating temperature such that regulation is controlled by the resistive properties of said first and second metal oxides.

30. The method according to claim 29, wherein said first metal oxide has a positive temperature coefficient and is applied as a plurality of layers.
